(19) United States
(12) Patent Application Publication
(10) Pub. No.: US 2023/0093470 A1
(43) Pub. Date: Mar. 23, 2023

(54) ACCOUNT AUTHORIZATION MAPPING

(71) Applicant: Salesforce, Inc., San Francisco, CA (US)

(72) Inventors: Thomas Charles Dvornik, Novato, CA (US); Alexei Kojenov, Portland, OR (US); Qingqing Liu, Dublin, CA (US)

(21) Appl. No.: 17/808,748

(22) Filed: Jun. 24, 2022

Related U.S. Application Data
(60) Provisional application No. 63/245,517, filed on Sep. 17, 2021.

(51) Int. Cl. H04L 9/40; H04L 67/306

(52) U.S. Cl. CPC H04L 63/083; H04L 67/306

(57) ABSTRACT

Methods and systems for account authorization mapping are described. An application server may transmit one or more authorization requests to one or more authorization entities associated with one or more applications. The application server may receive one or more access tokens associated with the one or more applications and may store one or more indications of authorization. The application server may further associate, at the authorization management entity, the one or more indications of authorization.

### CROSS REFERENCES

The present application for patent claims priority to U.S. Provisional Patent Application No. 63/245,517 by Dvornik et al., entitled “ACCOUNT AUTHORIZATION MAPPING,” filed Sep. 17, 2021, assigned to the assignee hereof, and expressly incorporated by reference herein.

### FIELD OF TECHNOLOGY

The present disclosure relates generally to database systems and data processing, and more specifically to account authorization mapping.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In the course of utilizing cloud platform resources, a user may have multiple accounts with multiple services. Each of these accounts may include or be associated with a log-in, sign-in, authorization, username, password, other credentials, or any combination thereof. A user may use these accounts in connection with the cloud platform resources. However, some approaches to user authentication or authorization may be deficient, and cohesive use of the accounts alongside the cloud platform resources may be limited.

### BRIEF DESCRIPTION OF THE DRAWINGS

FIG. 1 illustrates an example of a user authentication at an application server system that supports account authorization mapping in accordance with aspects of the present disclosure.

FIG. 2 illustrates an example of a system that supports account authorization mapping in accordance with aspects of the present disclosure.

FIG. 3 illustrates an example of a process flow that supports account authorization mapping in accordance with aspects of the present disclosure.

FIG. 4 shows a block diagram of an apparatus that supports account authorization mapping in accordance with aspects of the present disclosure.

FIG. 5 shows a block diagram of an authorization manager that supports account authorization mapping in accordance with aspects of the present disclosure.

FIG. 6 shows a diagram of a system including a device that supports account authorization mapping in accordance with aspects of the present disclosure.

FIGS. 7 and 8 show flowcharts illustrating methods that support account authorization mapping in accordance with aspects of the present disclosure.

### DETAILED DESCRIPTION

The subject matter disclosed herein describes approaches for managing, associating, linking, mapping, or otherwise managing multiple accounts for use in connection with cloud platform resources. A system may be provided with various rules, procedures, information, operation, or any combination thereof for performing such mapping, association, etc. Such mapping, association, etc., may be done in a secure manner by requesting authorization from external authorization entities that may be associated with the accounts that a user desires to map together or link and obtaining access tokens from the external authorization entities. Once the various authorizations have been obtained, the system may create and store the association between the various accounts to allow cohesive use of the accounts alongside the cloud platform resources.

For example, an application server may perform the approaches described herein. The application server may transmit a first authorization request to a first external authorization entity associated with the first account and may receive a first access token associated with the first application. The application server may also transmit a second authorization request to a second external authorization entity associated with the second account and may receive a second access token associated with the second application. The application server may store indications of these received access tokens and may thereby associate the stored indications to map the two accounts together for cohesive use of the accounts alongside the cloud platform resources.

The application server may also employ identity tokens to prevent attacks or assure that the user that is associating the accounts is the same user throughout the entire process. Further, the application server may receive requests for association from a user and may further receive a state parameter to initially verify the identity of a user that desires to associate or map multiple accounts. Further, the application server may participate in creation of an initial user account associated with the state parameter, and the application server may determine that the user associated with the user account is the same user that is requesting to map the user accounts.

Aspects of the disclosure are initially described in the context of an environment supporting an on-demand database service. Aspects are then described in the context of a system and a process flow. Aspects of the disclosure are further illustrated by and described with reference to apparatus diagrams, system diagrams, and flowcharts that relate to account authorization mapping.

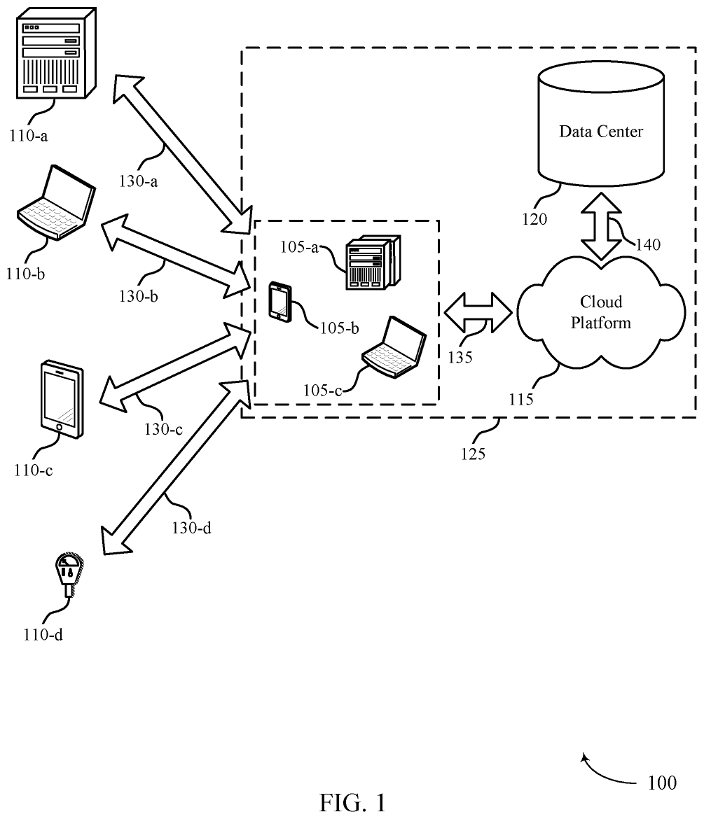

FIG. 1 illustrates an example of a system 100 for cloud computing that supports account authorization mapping in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

For example, the cloud platform 115 may receive a request from a cloud client 105 to associate or map multiple external accounts for use alongside the resources of the cloud platform 115. The cloud platform 115 may connect to or request authorization from the external accounts, and may receive access tokens for the respective accounts upon successful authorization with the external authorization entities. The cloud platform 115 may then associate or map the authorized accounts (e.g., by storing such an associate or mapping at the data center 120) for use by a cloud client 105 in connection with one or more cloud platform resources.

In some approaches, multiple accounts may not be mapped together or associated, and coordination of resources between accounts alongside cloud platform resources (especially when the accounts are not related with the cloud platform resources) becomes cumbersome. Further, some approaches to user account coordination or mapping may be subject to attacks by unauthorized users that may attempt to “hijack” an authorization or mapping process.

The approaches described herein provide approaches for securely mapping or associating multiple accounts associated with external resources for use alongside cloud platform resources. A system for mapping or association may request authorizations from the multiple accounts and may verify the identity of a requesting user throughout the user account association or mapping process. Further, the system may store indications of the various authorizations obtained from the external accounts or authorization entities and may thereby associate the various accounts. In this way, the system may resolve technical problems present that impede cohesive use of multiple accounts alongside cloud computing resources.

For example, if a user has two accounts (e.g., a messaging account and a project management account), the user may receive information from the messaging account that may be useful or needed in the resources of the management account. With some techniques, the user manually imports, moves, or manages the information between the various accounts, and this may quickly become cumbersome. Using the approaches herein, a user may request to a system that the messaging account and the project management account be associated or mapped for smoother operation. The system may then request authorization from the accounts via external authorization entities, where the user provides credentials for the external authorization entities, and the system may obtain the access tokens for the accounts. The system may then, based on the access tokens or associated indications of authorization, associate or map the accounts in the system or in connection with the cloud platform resources. In this way, the user may then use the multiple accounts in a cohesive manner in connection with the cloud platform resources.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

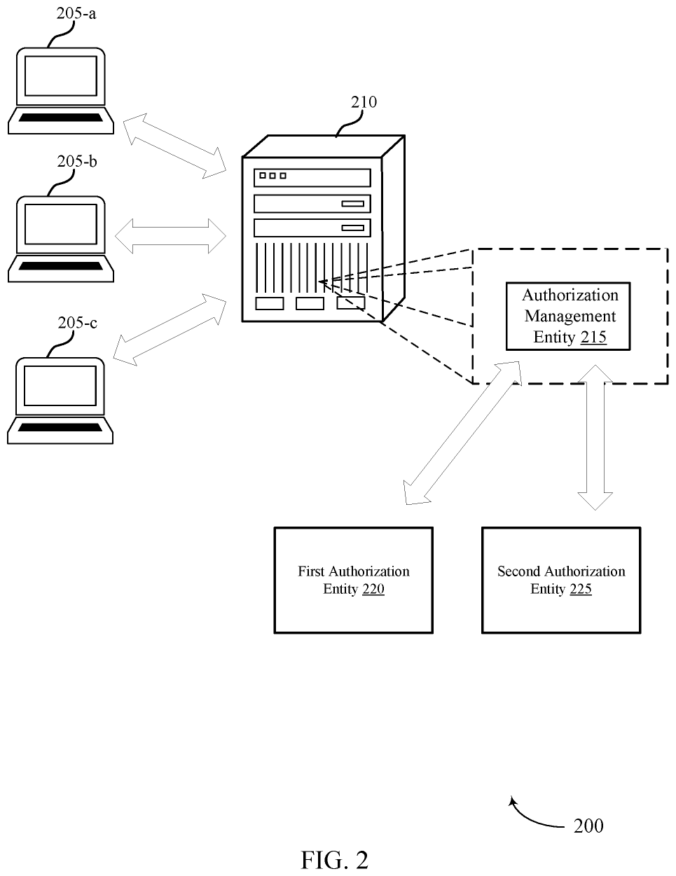

FIG. 2 illustrates an example of a system 200 that supports account authorization mapping in accordance with aspects of the present disclosure. The system 200 may include clients 205, application server 210, authorization management entity 215, first authorization entity 220, and second authorization entity 225. The application server 210 may perform operations for user accounts association or mapping. Though the approaches described herein may be described in examples where certain elements of the system 200 perform certain operations, it is to be understood that other elements of system 200 or other elements not shown in relation to system 200 may also perform operations described herein.

The application server 210 may implement techniques for integrating multiple accounts in the context of multi-tenant cloud computing platforms. For example, the application server 210 may integrate functionality between various accounts or products associated with a cloud computing platform. These various accounts may have separate user identities associated with the various accounts. However, it may be difficult to map the various user identities associated with the various accounts. The approaches described herein allow for authentication or authorization of third-party accounts through the cloud platform. Such authentication or authorization may include redirecting to an external account to provide authentication with the external account, and then may further include redirecting back to the cloud platform where interaction with the external account may then be authorized and possible.

The authorization management entity 215 may determine or perform logical operations for account authorization mapping. The authorization management entity 215 may coordinate such authorization mapping, storage of preferences, storage of tokens, data processing, housekeeping operations, or any combination thereof. The authorization management entity 215 may map the association between the external accounts and may do so in a secure way. The authorization management entity 215 may include a number of endpoints for mapping the external accounts for use with the cloud platform.

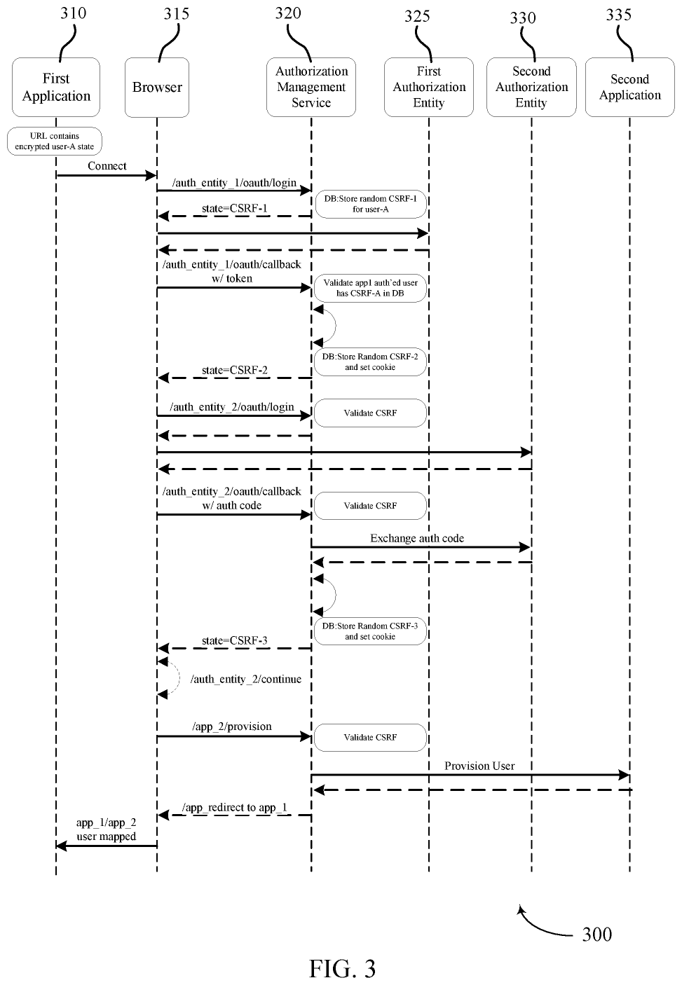

FIG. 3 illustrates an example of a process flow 300 that supports account authorization mapping in accordance with aspects of the present disclosure. Though the process flow 300 includes specific examples of various elements, these shall not be interpreted as limiting the disclosure to these specific examples. Rather, the process flow 300 depicted in FIG. 3 only provides one of many possible implementations or examples of account authorization mapping, and the procedures and operations disclosed herein are equally applicable to other entities, situations, processes, or operations.

First application 310 may be an example of an application (e.g., a messaging or chat application or any other application that requires user authentication), and second application 335 may be an example of a second application that requires user authentication (e.g., a learning management platform). The authorization management service 320 may be an example of an authorization management entity 215 which serves as a third-party authorization service as described in more detail herein. The first authorization entity 325 may be an example of the first authorization entity 220 (e.g., associated with authorization functions for the first application 310), and the second authorization entity 330 may be an example of the second authorization entity 225 (e.g., associated with authorization functions for the second application 335).

Generally speaking, the process flow 300 involves, but is not limited to, running two separate authorization flows with two different accounts, and then mapping or associating the two different accounts so that they may be used together alongside cloud computing platform resources.

When working in first application 310 (e.g., Slack © or any other application), a user may initiate an authentication or authorization mapping flow by transmitting a request to map or associated first application 310 and second application 335. The authentication process may involve a state parameter, that may be controlled by the cloud platform, the authorization management service 320, or another element.

The browser 315 may be connected to a page associated with the first authorization entity 325. The authorization management service 320 may connect to the first authorization entity 325 via an endpoint. At this point, the authorization management service 320 may verify the identity of the user requesting that first application 310 and second application 335 be connected or otherwise integrated, to avoid an attack where an unauthorized user connects a different, unrelated account associated with second application 335 to the account associated with the first application 310 and used by the authorized user. In some examples, when a user begins an authorization flow, instead of proceeding directly to the first authorization entity 325, the user may be redirected to the authorization management service 320 to manage linking of the accounts. The authorization management service 320 may redirect to the first authorization entity 325 for authentication. In some examples, the authorization management service 320 may manage cookies during part or all of the process flow 300 to manage identify verification, account authorization, other elements of the process flow 300, or any combination thereof. The authorization management service 320 may further redirect to the second authorization entity 330 for authentication at the second application 335. The results of the authentication at the first authorization entity 325 and the second authorization entity 330 may be stored at the authorization management service 320.

During the authentication process with the first authorization entity 325 or the second authorization entity 330, the authorization management service 320 may store one or more tokens at a database and may further store one or more cookies on a client device to aid in the authentication process. For examples, the authorization management service 320 may implement the use of cross site request forgery (CSRF) tokens in the cookies, at the database, or both. In some examples, the authorization management service 320 may validate at some or at every step of the process flow 300, the cookies stored on the user device or client device. The authorization management service 320 may exchange a token with the second authorization entity 330 to provide access to resources associated with second application 335 or second authorization entity 330. The CSRF tokens may be or may include JavaScript Object Notation (JSON) web tokens.

The authorization management service 320 may also provision a user, as shown in FIG. 3. The authorization management service 320 may store a mapping between a first application 310 user account and a second application 335 account. The authorization management service 320 or other element may provide a notification to the user that the accounts have been linked and that the user is authenticated with both of the applications.

First application 310 and second application 335 may be any application, website, or other resource that a user may wish to use or connect to another application, website, mobile application, or other resources. In some examples, an application to be connected may be an application that does not “own” an identity used with the application. For example, an application (e.g., a shopping application) may be authorized to work with or use another account (e.g., an email account) for operation of the application. Such an application may still be used with the approaches described herein. In some examples, the application used to initiate the process (e.g., first application 310) may be associated with one of the identity providers (e.g., first authorization entity 325 or second authorization entity 330) or it may not be associated with one of the identity providers. In some examples, an endpoint of the authorization management service 320 may not require verification of an identity, as it may be the first point of contact in such an authentication flow as shown by the example process flow 300. However, if the application used to begin the process (e.g., first application 310) is associated with one of the identify providers (e.g., first authorization entity 325), the authorization management service 320 may already know or be aware of an identity of the user and may use this identity during part or all of the process flow 300. The authorization management service 320 may verify that the same user is the user that is engaging in all steps of the process flow 300.

After authenticating with the first authorization entity 325, the authorization management service 320 or other element may verify the identity of the user engaging in the mapping process. However, an unauthorized user may attempt to “hijack” the process and attempt to associate a different, unauthorized account with the first application 310 account. To mitigate or reduce such attacks, the authorization management service 320 may employ CSRF tokens. Such tokens or other credentials may be verified by the authorization management service 320 or other elements to reduce or mitigate attacks using unauthorized accounts. A state token may contain information associated with a user, and such information may be available to the authorization management service 320 by virtue of an existing login to first application 310. At points during the process flow 300, the authorization management service 320 may validate or determine that a user at a point in the process is the same user that was either logged into first application 310 or that initiated the account mapping flow in the first place. If such validation or determination is unsuccessful, the authorization management service 320 may not attempt to authenticate with the second authorization entity 330 or the second application 335 account and may not attempt to map or associated the first application 310 account and the second application 335 account. User information (e.g., user information included in the state parameter, token, or other element used to verify identity) may include a user identifier, a team identifier, an enterprise identifier, an application identifier, other information that may be validated, or any combination thereof. Such information may be validated with authentication providers, such as first authorization entity 325 or second authorization entity 330 as described herein. The authorization management service 320 may validate one or more payloads receive from the first authorization entity 325 or the second authorization entity 330. The payloads may include information such as a user identifier, a user's name, a user's email address, a token, or any combination thereof. The token may be exchanged (e.g., with first application 310, first authorization entity 325, second authorization entity 330, second application 335, or any combination thereof) for another token that may provide access to resources of one or more applications or resources.

The authorization management service 320 may validate a received piece of validation information by verifying that the validation information could only have been created by or with the assistance of the authorization management service 320, thereby assuring that the user that initiated the mapping process (and, optionally, creating the validation information in the first place) is the user that is continuing with the mapping process.

The authorization management service 320 may further attempt to authenticate with second authorization entity 330 to link the second application 335 account. In some examples, the authorization management service 320 may create or use a new encrypted token at various points within the process flow 300. For example, the authorization management service 320 may create or use a new encrypted token in connection with authenticating with first authorization entity 325 and may create or use yet another encrypted token in connection with authenticating with second authorization entity 330. In some examples, the authorization management service 320 may generate or use a new token after validating a previous token. Further the authorization management service 320 may validate that a previous token came from or was associated with an immediately previous operation or step in the mapping process, thereby reducing or preventing attacks where an unauthorized user may interrupt or skip past one or more portions of the mapping procedure.

In some examples, the authorization management service 320 may perform a callback from the second authorization entity 330, and the authorization management service 320 may exchange one or more authorization codes with the second authorization entity 330. Such authorization codes may be a one-time use code for gaining access to resources associated with an account (e.g., second application 335). Such a one-time use code may be exchanged for an access token (e.g., that may be used for making application programming interface (API) calls or other interfacing with an account such as second application 335 or first application 310). In some examples, the authorization management service 320 may verify an identify of a user (e.g., through the use of the CSRF tokens, the state parameter, other mechanisms, or any combination thereof) based on a redirect. For example, the authorization management service 320 may verify such an identify every time that a user or browser 315 is redirected from one website or resource to another during the account mapping process.

In some examples, the authorization management service 320 may provision a user with the second application 335 app. In some examples, this may be performed after requesting and receiving authorization from first application 310 or first authorization entity 325 and second application 335 or second authorization entity 330. Further, such provisioning may be performed after associating or mapping the accounts (e.g., at the authorization management service 320).

In some examples, the authorization management service 320 may use alternative pieces of information for identify verification. For example, the authorization management service 320 may use an email address, a first application 310 identifier, a second application 335 identifier, an identifier associated with an external service, or any combination thereof for identity verification. Such an identifier may be one or more pieces of information that may be used by the authorization management service 320 to make sure that the user requesting the mapping process is the same user that is authenticating at the first authorization entity 325 and the second authorization entity 330, for example.

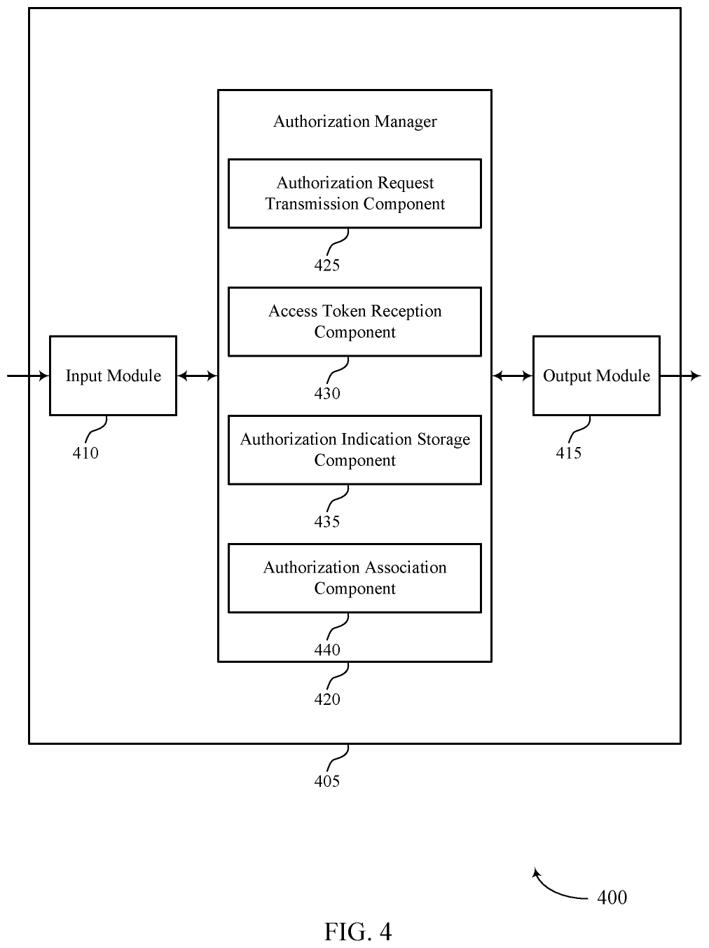

FIG. 4 shows a block diagram 400 of a device 405 that supports account authorization mapping in accordance with aspects of the present disclosure. The device 405 may include an input module 410, an output module 415, and an authorization manager 420. The device 405 may also include a processor. Each of these components may be in communication with one another (e.g., via one or more buses).

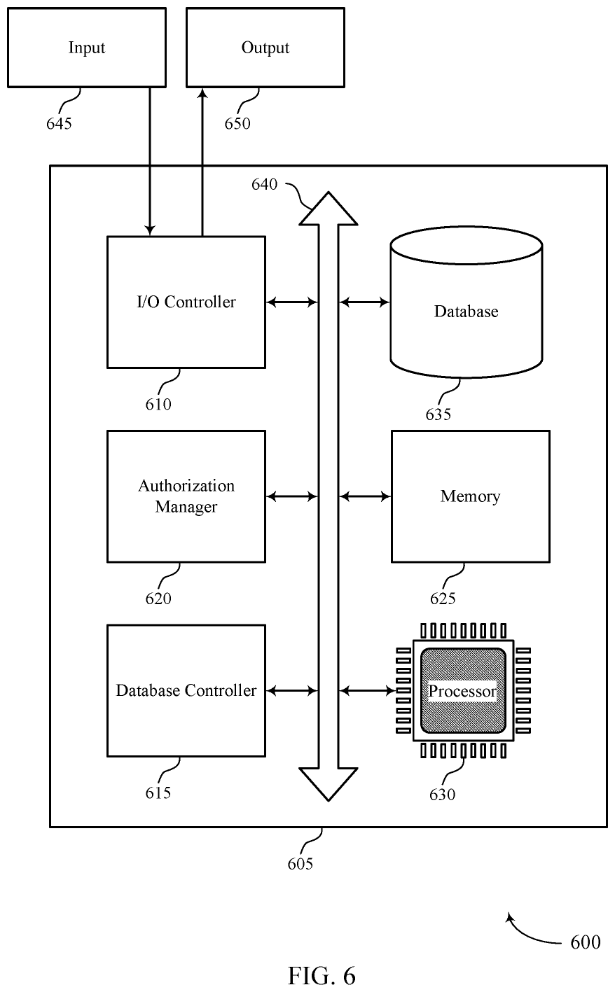

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the authorization manager 420 to support account authorization mapping. In some cases, the input module 410 may be a component of an I/O controller 610 as described with reference to FIG. 6.

The output module 415 may manage output signals for the device 405. For example, the output module 415 may receive signals from other components of the device 405, such as the authorization manager 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the authorization manager 420 may include an authorization request transmission component 425, an access token reception component 430, an authorization indication storage component 435, an authorization association component 440, or any combination thereof. In some examples, the authorization manager 420, or various components thereof, may be configured to perform various operations (e.g., receiving, monitoring, transmitting) using or otherwise in cooperation with the input module 410, the output module 415, or both. For example, the authorization manager 420 may receive information from the input module 410, send information to the output module 415, or be integrated in combination with the input module 410, the output module 415, or both to receive information, transmit information, or perform various other operations as described herein.

The authorization manager 420 may support user authentication at an application server in accordance with examples as disclosed herein. The authorization request transmission component 425 may be configured as or otherwise support a means for transmitting, from the authorization management entity to a first authorization entity associated with the first application, a first authorization request based at least in part on a state parameter that identifies a user. The access token reception component 430 may be configured as or otherwise support a means for receiving, at the authorization management entity and from the first authorization entity, a first access token associated with the first application. The authorization indication storage component 435 may be configured as or otherwise support a means for storing, at the authorization management entity, a first indication of authorization associated with the user and the first application based at least in part on receiving the first access token. The authorization request transmission component 425 may be configured as or otherwise support a means for transmitting, from the authorization management entity to a second authorization entity associated with a second application, a second authorization request based at least in part on the state parameter. The access token reception component 430 may be configured as or otherwise support a means for receiving, at the authorization management entity and from the second authorization entity, a second access token associated with the first application. The authorization indication storage component 435 may be configured as or otherwise support a means for storing, at the authorization management entity, a second indication of authorization associated with the user and the second application based at least in part on receiving the second access token. The authorization association component 440 may be configured as or otherwise support a means for associating, at the authorization management entity, the first indication of authorization and the second indication of authorization.

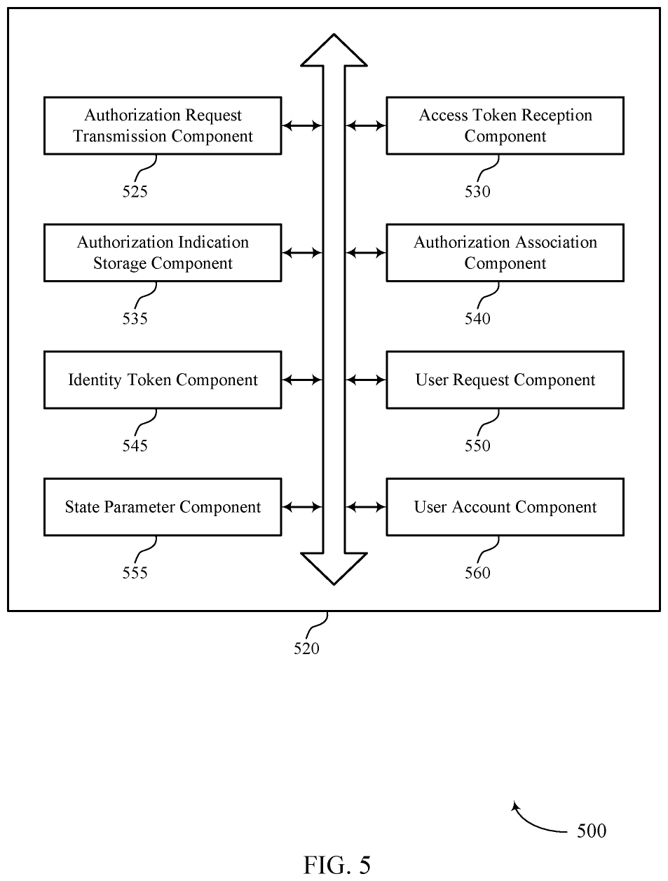

FIG. 5 shows a block diagram 500 of an authorization manager 520 that supports account authorization mapping in accordance with aspects of the present disclosure. The authorization manager 520 may be an example of aspects of an authorization manager or an authorization manager 420, or both, as described herein. The authorization manager 520, or various components thereof, may be an example of means for performing various aspects of account authorization mapping as described herein. For example, the authorization manager 520 may include an authorization request transmission component 525, an access token reception component 530, an authorization indication storage component 535, an authorization association component 540, an identity token component 545, a user request component 550, a state parameter component 555, a user account component 560, or any combination thereof. Each of these components may communicate, directly or indirectly, with one another (e.g., via one or more buses).

The authorization manager 520 may support user authentication at an application server in accordance with examples as disclosed herein. The authorization request transmission component 525 may be configured as or otherwise support a means for transmitting, from the authorization management entity to a first authorization entity associated with the first application, a first authorization request based at least in part on a state parameter that identifies a user. The access token reception component 530 may be configured as or otherwise support a means for receiving, at the authorization management entity and from the first authorization entity, a first access token associated with the first application. The authorization indication storage component 535 may be configured as or otherwise support a means for storing, at the authorization management entity, a first indication of authorization associated with the user and the first application based at least in part on receiving the first access token. In some examples, the authorization request transmission component 525 may be configured as or otherwise support a means for transmitting, from the authorization management entity to a second authorization entity associated with a second application, a second authorization request based at least in part on the state parameter. In some examples, the access token reception component 530 may be configured as or otherwise support a means for receiving, at the authorization management entity and from the second authorization entity, a second access token associated with the first application. In some examples, the authorization indication storage component 535 may be configured as or otherwise support a means for storing, at the authorization management entity, a second indication of authorization associated with the user and the second application based at least in part on receiving the second access token. The authorization association component 540 may be configured as or otherwise support a means for associating, at the authorization management entity, the first indication of authorization and the second indication of authorization.

In some examples, transmitting the first authorization request is based at least in part on a first identity token associated with the first authorization request. In some examples, transmitting the second authorization request is based at least in part on a second identity token associated with the second authorization request.

In some examples, the identity token component 545 may be configured as or otherwise support a means for verifying the first identity token, wherein transmitting the second authorization request is based at least in part on verifying the first identity token.

In some examples, the user request component 550 may be configured as or otherwise support a means for receiving, from a user, an authorization association request for the first application and the second application.

In some examples, the state parameter component 555 may be configured as or otherwise support a means for receiving, at the authorization management entity and from the first application, the state parameter, wherein the state parameter is associated with a user account associated with the first application.

In some examples, the user account component 560 may be configured as or otherwise support a means for creating a user account associated with the first application, wherein the state parameter is based at least in part on creating the user account associated with the first application.

FIG. 6 shows a diagram of a system 600 including a device 605 that supports account authorization mapping in accordance with aspects of the present disclosure. The device 605 may be an example of or include the components of a device 405 as described herein. The device 605 may include components for bi-directional data communications including components for transmitting and receiving communications, such as an authorization manager 620, an I/O controller 610, a database controller 615, a memory 625, a processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and ROM. The memory 625 may store computer-readable, computer-executable software including instructions that, when executed, cause the processor 630 to perform various functions described herein. In some cases, the memory 625 may contain, among other things, a BIOS which may control basic hardware or software operation such as the interaction with peripheral components or devices.

The processor 630 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in a memory 625 to perform various functions (e.g., functions or tasks supporting account authorization mapping).

The authorization manager 620 may support user authentication at an application server in accordance with examples as disclosed herein. For example, the authorization manager 620 may be configured as or otherwise support a means for transmitting, from the authorization management entity to a first authorization entity associated with the first application, a first authorization request based at least in part on a state parameter that identifies a user. The authorization manager 620 may be configured as or otherwise support a means for receiving, at the authorization management entity and from the first authorization entity, a first access token associated with the first application. The authorization manager 620 may be configured as or otherwise support a means for storing, at the authorization management entity, a first indication of authorization associated with the user and the first application based at least in part on receiving the first access token. The authorization manager 620 may be configured as or otherwise support a means for transmitting, from the authorization management entity to a second authorization entity associated with a second application, a second authorization request based at least in part on the state parameter. The authorization manager 620 may be configured as or otherwise support a means for receiving, at the authorization management entity and from the second authorization entity, a second access token associated with the first application. The authorization manager 620 may be configured as or otherwise support a means for storing, at the authorization management entity, a second indication of authorization associated with the user and the second application based at least in part on receiving the second access token. The authorization manager 620 may be configured as or otherwise support a means for associating, at the authorization management entity, the first indication of authorization and the second indication of authorization.

By including or configuring the authorization manager 620 in accordance with examples as described herein, the device 605 may support techniques for improved communication reliability, reduced latency, improved user experience related to reduced processing, reduced power consumption, more efficient utilization of communication resources, improved coordination between devices, longer battery life, improved utilization of processing capability, or a combination thereof.

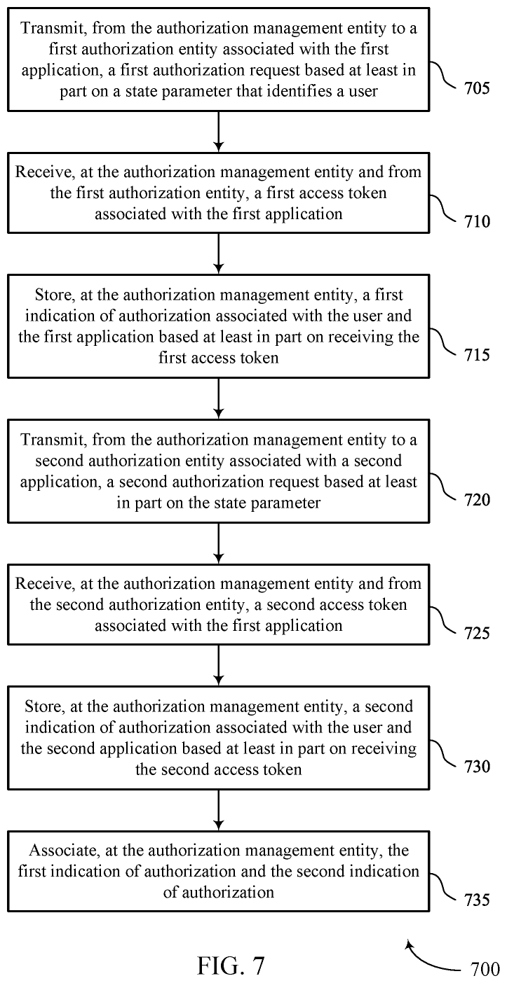

FIG. 7 shows a flowchart illustrating a method 700 that supports account authorization mapping in accordance with aspects of the present disclosure. The operations of the method 700 may be implemented by an application server or its components as described herein. For example, the operations of the method 700 may be performed by an application server as described with reference to FIGS. 1 through 6. In some examples, an application server may execute a set of instructions to control the functional elements of the application server to perform the described functions. Additionally or alternatively, the application server may perform aspects of the described functions using special-purpose hardware.

At 705, the method may include transmitting, from the authorization management entity to a first authorization entity associated with the first application, a first authorization request based at least in part on a state parameter that identifies a user. The operations of 705 may be performed in accordance with examples as disclosed herein. In some examples, aspects of the operations of 705 may be performed by an authorization request transmission component 525 as described with reference to FIG. 5.

At 710, the method may include receiving, at the authorization management entity and from the first authorization entity, a first access token associated with the first application. The operations of 710 may be performed in accordance with examples as disclosed herein. In some examples, aspects of the operations of 710 may be performed by an access token reception component 530 as described with reference to FIG. 5.

At 715, the method may include storing, at the authorization management entity, a first indication of authorization associated with the user and the first application based at least in part on receiving the first access token. The operations of 715 may be performed in accordance with examples as disclosed herein. In some examples, aspects of the operations of 715 may be performed by an authorization indication storage component 535 as described with reference to FIG. 5.

At 720, the method may include transmitting, from the authorization management entity to a second authorization entity associated with a second application, a second authorization request based at least in part on the state parameter. The operations of 720 may be performed in accordance with examples as disclosed herein. In some examples, aspects of the operations of 720 may be performed by an authorization request transmission component 525 as described with reference to FIG. 5.

At 725, the method may include receiving, at the authorization management entity and from the second authorization entity, a second access token associated with the first application. The operations of 725 may be performed in accordance with examples as disclosed herein. In some examples, aspects of the operations of 725 may be performed by an access token reception component 530 as described with reference to FIG. 5.

At 730, the method may include storing, at the authorization management entity, a second indication of authorization associated with the user and the second application based at least in part on receiving the second access token. The operations of 730 may be performed in accordance with examples as disclosed herein. In some examples, aspects of the operations of 730 may be performed by an authorization indication storage component 535 as described with reference to FIG. 5.

At 735, the method may include associating, at the authorization management entity, the first indication of authorization and the second indication of authorization. The operations of 735 may be performed in accordance with examples as disclosed herein. In some examples, aspects of the operations of 735 may be performed by an authorization association component 540 as described with reference to FIG. 5.

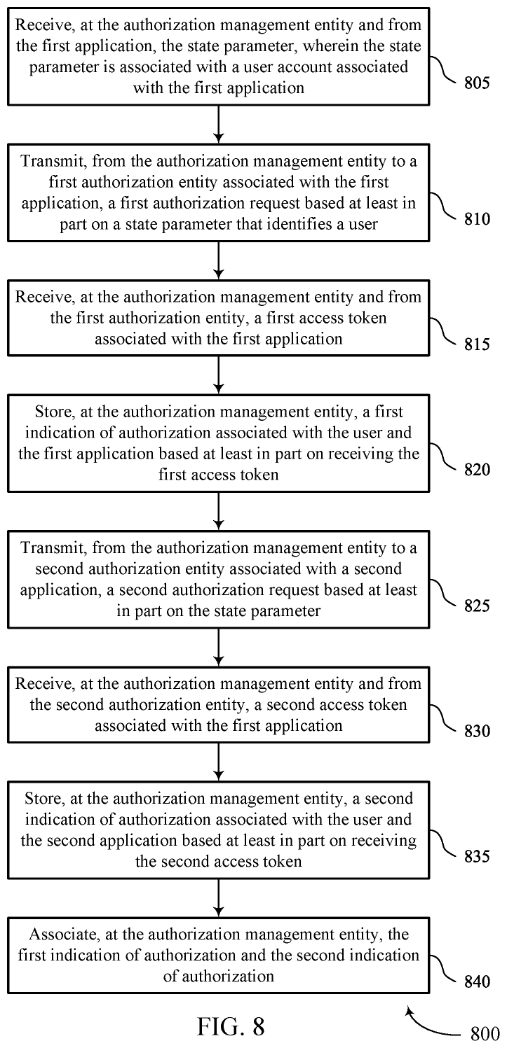

FIG. 8 shows a flowchart illustrating a method 800 that supports account authorization mapping in accordance with aspects of the present disclosure. The operations of the method 800 may be implemented by an application server or its components as described herein. For example, the operations of the method 800 may be performed by an application server as described with reference to FIGS. 1 through 6. In some examples, an application server may execute a set of instructions to control the functional elements of the application server to perform the described functions. Additionally or alternatively, the application server may perform aspects of the described functions using special-purpose hardware.

At 805, the method may include receiving, at the authorization management entity and from the first application, the state parameter, wherein the state parameter is associated with a user account associated with the first application. The operations of 805 may be performed in accordance with examples as disclosed herein. In some examples, aspects of the operations of 805 may be performed by a state parameter component 555 as described with reference to FIG. 5.

At 810, the method may include transmitting, from the authorization management entity to a first authorization entity associated with the first application, a first authorization request based at least in part on a state parameter that identifies a user. The operations of 810 may be performed in accordance with examples as disclosed herein. In some examples, aspects of the operations of 810 may be performed by an authorization request transmission component 525 as described with reference to FIG. 5.

At 815, the method may include receiving, at the authorization management entity and from the first authorization entity, a first access token associated with the first application. The operations of 815 may be performed in accordance with examples as disclosed herein. In some examples, aspects of the operations of 815 may be performed by an access token reception component 530 as described with reference to FIG. 5.

At 820, the method may include storing, at the authorization management entity, a first indication of authorization associated with the user and the first application based at least in part on receiving the first access token. The operations of 820 may be performed in accordance with examples as disclosed herein. In some examples, aspects of the operations of 820 may be performed by an authorization indication storage component 535 as described with reference to FIG. 5.

At 825, the method may include transmitting, from the authorization management entity to a second authorization entity associated with a second application, a second authorization request based at least in part on the state parameter. The operations of 825 may be performed in accordance with examples as disclosed herein. In some examples, aspects of the operations of 825 may be performed by an authorization request transmission component 525 as described with reference to FIG. 5.

At 830, the method may include receiving, at the authorization management entity and from the second authorization entity, a second access token associated with the first application. The operations of 830 may be performed in accordance with examples as disclosed herein. In some examples, aspects of the operations of 830 may be performed by an access token reception component 530 as described with reference to FIG. 5.

At 835, the method may include storing, at the authorization management entity, a second indication of authorization associated with the user and the second application based at least in part on receiving the second access token. The operations of 835 may be performed in accordance with examples as disclosed herein. In some examples, aspects of the operations of 835 may be performed by an authorization indication storage component 535 as described with reference to FIG. 5.

At 840, the method may include associating, at the authorization management entity, the first indication of authorization and the second indication of authorization. The operations of 840 may be performed in accordance with examples as disclosed herein. In some examples, aspects of the operations of 840 may be performed by an authorization association component 540 as described with reference to FIG. 5.

A method for user authentication at an application server is described. The method may include transmitting, from an authorization management entity to a first authorization entity associated with a first application, a first authorization request based at least in part on a state parameter that identifies a user, receiving, at the authorization management entity and from the first authorization entity, a first access token associated with the first application, storing, at the authorization management entity, a first indication of authorization associated with the user and the first application based at least in part on receiving the first access token, transmitting, from the authorization management entity to a second authorization entity associated with a second application, a second authorization request based at least in part on the state parameter, receiving, at the authorization management entity and from the second authorization entity, a second access token associated with the first application, storing, at the authorization management entity, a second indication of authorization associated with the user and the second application based at least in part on receiving the second access token, and associating, at the authorization management entity, the first indication of authorization and the second indication of authorization.

An apparatus for user authentication at an application server is described. The apparatus may include a processor, memory coupled with the processor, and instructions stored in the memory. The instructions may be executable by the processor to cause the apparatus to transmit, from an authorization management entity to a first authorization entity associated with a first application, a first authorization request based at least in part on a state parameter that identifies a user, receive, at the authorization management entity and from the first authorization entity, a first access token associated with the first application, store, at the authorization management entity, a first indication of authorization associated with the user and the first application based at least in part on receiving the first access token, transmit, from the authorization management entity to a second authorization entity associated with a second application, a second authorization request based at least in part on the state parameter, receive, at the authorization management entity and from the second authorization entity, a second access token associated with the first application, store, at the authorization management entity, a second indication of authorization associated with the user and the second application based at least in part on receiving the second access token, and associate, at the authorization management entity, the first indication of authorization and the second indication of authorization.

Another apparatus for user authentication at an application server is described. The apparatus may include means for transmitting, from an authorization management entity to a first authorization entity associated with a first application, a first authorization request based at least in part on a state parameter that identifies a user, means for receiving, at the authorization management entity and from the first authorization entity, a first access token associated with the first application, means for storing, at the authorization management entity, a first indication of authorization associated with the user and the first application based at least in part on receiving the first access token, means for transmitting, from the authorization management entity to a second authorization entity associated with a second application, a second authorization request based at least in part on the state parameter, means for receiving, at the authorization management entity and from the second authorization entity, a second access token associated with the first application, means for storing, at the authorization management entity, a second indication of authorization associated with the user and the second application based at least in part on receiving the second access token, and means for associating, at the authorization management entity, the first indication of authorization and the second indication of authorization.

A non-transitory computer-readable medium storing code for user authentication at an application server is described. The code may include instructions executable by a processor to transmit, from an authorization management entity to a first authorization entity associated with a first application, a first authorization request based at least in part on a state parameter that identifies a user, receive, at the authorization management entity and from the first authorization entity, a first access token associated with the first application, store, at the authorization management entity, a first indication of authorization associated with the user and the first application based at least in part on receiving the first access token, transmit, from the authorization management entity to a second authorization entity associated with a second application, a second authorization request based at least in part on the state parameter, receive, at the authorization management entity and from the second authorization entity, a second access token associated with the first application, store, at the authorization management entity, a second indication of authorization associated with the user and the second application based at least in part on receiving the second access token, and associate, at the authorization management entity, the first indication of authorization and the second indication of authorization.

Some examples of the method, apparatuses, and non-transitory computer-readable medium described herein may further include operations, features, means, or instructions for transmitting the first authorization request may be based at least in part on a first identity token associated with the first authorization request and transmitting the second authorization request may be based at least in part on a second identity token associated with the second authorization request.

Some examples of the method, apparatuses, and non-transitory computer-readable medium described herein may further include operations, features, means, or instructions for verifying the first identity token, wherein transmitting the second authorization request may be based at least in part on verifying the first identity token.

Some examples of the method, apparatuses, and non-transitory computer-readable medium described herein may further include operations, features, means, or instructions for receiving, from a user, an authorization association request for the first application and the second application.

Some examples of the method, apparatuses, and non-transitory computer-readable medium described herein may further include operations, features, means, or instructions for receiving, at the authorization management entity and from the first application, the state parameter, wherein the state parameter may be associated with a user account associated with the first application.

Some examples of the method, apparatuses, and non-transitory computer-readable medium described herein may further include operations, features, means, or instructions for creating a user account associated with the first application, wherein the state parameter may be based at least in part on creating the user account associated with the first application.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for user authentication at an application server, comprising:
transmitting, from an authorization management entity to a first authorization entity associated with a first application, a first authorization request based at least in part on a state parameter that identifies a user;
receiving, at the authorization management entity and from the first authorization entity, a first access token associated with the first application;
storing, at the authorization management entity, a first indication of authorization associated with the user and the first application based at least in part on receiving the first access token;
transmitting, from the authorization management entity to a second authorization entity associated with a second application, a second authorization request based at least in part on the state parameter;
receiving, at the authorization management entity and from the second authorization entity, a second access token associated with the first application;
storing, at the authorization management entity, a second indication of authorization associated with the user and the second application based at least in part on receiving the second access token; and
associating, at the authorization management entity, the first indication of authorization and the second indication of authorization.

2. The method of claim 1, wherein:
transmitting the first authorization request is based at least in part on a first identity token associated with the first authorization request; and
transmitting the second authorization request is based at least in part on a second identity token associated with the second authorization request.

3. The method of claim 2, further comprising:
verifying the first identity token, wherein transmitting the second authorization request is based at least in part on verifying the first identity token.

4. The method of claim 1, further comprising:
receiving, from a user, an authorization association request for the first application and the second application.

5. The method of claim 1, further comprising:
receiving, at the authorization management entity and from the first application, the state parameter, wherein the state parameter is associated with a user account associated with the first application.

6. The method of claim 1, further comprising:
creating a user account associated with the first application, wherein the state parameter is based at least in part on creating the user account associated with the first application.

7. An apparatus for user authentication at an application server, comprising:
a processor;
memory coupled with the processor; and
instructions stored in the memory and executable by the processor to cause the apparatus to:
transmit, from an authorization management entity to a first authorization entity associated with a first application, a first authorization request based at least in part on a state parameter that identifies a user;
receive, at the authorization management entity and from the first authorization entity, a first access token associated with the first application;
store, at the authorization management entity, a first indication of authorization associated with the user and the first application based at least in part on receiving the first access token;
transmit, from the authorization management entity to a second authorization entity associated with a second application, a second authorization request based at least in part on the state parameter;
receive, at the authorization management entity and from the second authorization entity, a second access token associated with the first application;
store, at the authorization management entity, a second indication of authorization associated with the user and the second application based at least in part on receiving the second access token; and
associate, at the authorization management entity, the first indication of authorization and the second indication of authorization.

8. The apparatus of claim 7, wherein:
transmitting the first authorization request is based at least in part on a first identity token associated with the first authorization request; and
transmitting the second authorization request is based at least in part on a second identity token associated with the second authorization request.

9. The apparatus of claim 8, wherein the instructions are further executable by the processor to cause the apparatus to:
verify the first identity token, wherein transmitting the second authorization request is based at least in part on verifying the first identity token.

10. The apparatus of claim 7, wherein the instructions are further executable by the processor to cause the apparatus to:
receive, from a user, an authorization association request for the first application and the second application.

11. The apparatus of claim 7, wherein the instructions are further executable by the processor to cause the apparatus to:
receive, at the authorization management entity and from the first application, the state parameter, wherein the state parameter is associated with a user account associated with the first application.

12. The apparatus of claim 7, wherein the instructions are further executable by the processor to cause the apparatus to:
create a user account associated with the first application, wherein the state parameter is based at least in part on creating the user account associated with the first application.

13. A non-transitory computer-readable medium storing code for user authentication at an application server, the code comprising instructions executable by a processor to:
transmit, from an authorization management entity to a first authorization entity associated with a first application, a first authorization request based at least in part on a state parameter that identifies a user;
receive, at the authorization management entity and from the first authorization entity, a first access token associated with the first application;
store, at the authorization management entity, a first indication of authorization associated with the user and the first application based at least in part on receiving the first access token;
transmit, from the authorization management entity to a second authorization entity associated with a second application, a second authorization request based at least in part on the state parameter;
receive, at the authorization management entity and from the second authorization entity, a second access token associated with the first application;
store, at the authorization management entity, a second indication of authorization associated with the user and the second application based at least in part on receiving the second access token; and
associate, at the authorization management entity, the first indication of authorization and the second indication of authorization.

14. The non-transitory computer-readable medium of claim 13, wherein:
transmitting the first authorization request is based at least in part on a first identity token associated with the first authorization request; and
transmitting the second authorization request is based at least in part on a second identity token associated with the second authorization request.

15. The non-transitory computer-readable medium of claim 14, wherein the instructions are further executable by the processor to:
verify the first identity token, wherein transmitting the second authorization request is based at least in part on verifying the first identity token.

16. The non-transitory computer-readable medium of claim 13, wherein the instructions are further executable by the processor to:
receive, from a user, an authorization association request for the first application and the second application.

17. The non-transitory computer-readable medium of claim 13, wherein the instructions are further executable by the processor to:
receive, at the authorization management entity and from the first application, the state parameter, wherein the state parameter is associated with a user account associated with the first application.

18. The non-transitory computer-readable medium of claim 13, wherein the instructions are further executable by the processor to:
create a user account associated with the first application, wherein the state parameter is based at least in part on creating the user account associated with the first application.
